(19) United States
(12) Patent Application Publication
(10) Pub. No.: US 2011/0256472 A1
(43) Pub. Date: Oct. 20, 2011

(54) Catalyst Slurry Composition for Fuel Cell Electrode, Catalytic Layer for Fuel Cell Electrode Using the Catalyst Slurry Composition, Method for Producing the Catalytic Layer and Membrane-Electrode Assembly Including the Catalytic Layer

(75) Inventors: Tae Kyoung KIM, Uiwang-si (KR); Yeong Suk CHOI, Uiwang-si (KR); Yoon Hoi LEE, Uiwang-si (KR)

(73) Assignee: CHEIL INDUSTRIES INC., Gumi-si (KR)

(21) Appl. No.: 13/006,675

(22) Filed: Jan. 14, 2011

(30) Foreign Application Priority Data
Apr. 16, 2010 (KR) 10-2010-0035266

(51) Int. Cl. H01M 4/62; H01M 4/88; B01J 31/06; B82Y 30/00

(52) U.S. Cl. 429/532; 502/159; 502/101; 977/773

(57) ABSTRACT

Disclosed herein is a catalyst slurry composition for an electrode of a fuel cell. The catalyst slurry composition includes 100 parts by weight of an active metal, about 5 to about 30 parts by weight of a binder polymer, and about 6 to about 70 parts by weight of silica. Use of the catalyst slurry composition can provide control of the volume of pores accordingly can improve the performance of a fuel cell.

### CROSS-REFERENCE TO RELATED APPLICATIONS

This application claims priority under 35 USC Section 119 from Korean Patent Application No. 10-2010-0035266, filed Apr. 16, 2010, in the Korean Intellectual Property Office, the entire disclosure of which is incorporated herein by reference.

### FIELD OF THE INVENTION

The present invention relates to a catalyst slurry composition for a fuel cell electrode, a catalytic layer for a fuel cell electrode using the catalyst slurry composition, a method for producing the catalytic layer, and a membrane-electrode assembly including the catalytic layer.

### BACKGROUND OF THE INVENTION

Fuel cells are newly developed electrochemical devices that directly convert the chemical energy of hydrogen (H₂) and oxygen (O₂) into electric energy. In a typical fuel cell, hydrogen and oxygen are fed into an anode and a cathode, respectively, to continuously produce electricity. Such fuel cells are clean energy sources that can generate electricity with an overall efficiency as high as 80% without causing pollution factors such as NOx, CO₂ and noise. For these reasons, fuel cells have received considerable attention as next-generation energy conversion systems.

Fuel cells are classified into phosphoric acid fuel cells (PAFCs), alkaline fuel cells (AFCs), polymer electrolyte membrane fuel cells (PEMFCs), molten carbonate fuel cells (MCFCs), solid oxide fuel cells (SOFCs) and direct methanol fuel cells (DMFCs) according to the kind of electrolyte that they employ. The six types of fuel cells are operated based on the same fundamental operational principle but are different in terms of the kind of fuel, operational temperatures, catalysts and electrolytes they use.

Of these, polymer electrolyte fuel cells (PEFCs) using a polymer membrane have generated particular interest due to their high energy density and high output. The performance of polymer electrolyte fuel cells tends to deteriorate over time, which is highly associated with a decrease in reaction potential at a constant current value. Primary causes of the decreased reaction potential are a decrease in potential by slow activation of a catalyst (‘activation loss’), a decrease in open circuit voltage (OCV) by reverse potential arising from the cross-over of fuel into a counter electrode, a decrease in potential by ohmic resistance to ionic conduction in a polymer membrane (‘ohmic loss’), and a decrease in potential by mass transport resistance arising from the exhaustion of fuel and accumulation of by-products at catalyst interfaces (‘mass transport loss’).

Thus, many attempts have been made to improve the performance of fuel cells. For example, a method is currently being developed in which a porous catalytic layer is used in a membrane-electrode assembly to ensure a constant feed of fuel into a catalyst of the catalytic layer and easy discharge of by-products (e.g., water) from the catalytic layer.

It is very important to control the size and volume of pores in a catalytic layer in order to contribute to an improvement in the performance of a fuel cell. In a fuel cell system using fuel such as hydrogen or methanol, the hydrogen reacts with oxygen ions in a cathode to create water. If a catalytic layer suffers from excessive water flooding, air (specifically oxygen in air) has difficulty in penetrating the catalytic layer of the cathode, bringing about a reduction in the performance of the fuel cell. Accordingly, an approach to control the size and volume of pores in the catalytic layer such that water is discharged without any difficulty from the catalytic layer of the cathode will improve the supply of fuel to the catalyst, ensuring improved performance and long-term use of the fuel cell.

A catalyst slurry for a polymer electrolyte membrane fuel cell (PEMFC) usually includes a catalyst, a cationic conductive polymer as an ionomer, a solvent, and other additives, among other components. After the catalyst slurry is cast and dried, a large proportion of the catalyst is trapped within the cationic conductive polymer and is present within the catalytic layer, thus preventing fuels (hydrogen, oxygen, methanol, etc.) from arriving at the catalyst surface or inside the catalytic layer. As a result, the delayed migration of the fuels acts as a rate-limiting factor in the catalytic layer, leading to a substantial reduction in the availability of the catalyst constituting the catalytic layer. When the size and number of pores in the catalytic layer are appropriately controlled, the catalyst present within the catalyst or the catalyst trapped within the binder polymer can effectively react with the fuels and hence the performance of the fuel cell can be improved.

Porous catalytic layers can be produced from a mixture of a slurry and a plasticizer, an inorganic salt or a pore-forming member.

Korean Unexamined Patent Publication No. 2006-0054749 discloses a method for forming fine pores by using a mixture of a cationic conductive polymer as an ionomer for a catalytic layer and a plasticizer. Examples of such plasticizers include polyalkylene glycol, polyalkylene oxide, poly(alkyl)acrylic acid, polymers having sulfonic acid groups, cellulose-based polymers, diethyl phthalate (DEP), dibutyl phthalate (DBP), dioctyl phthalate (DOP), phosphates, and dioctyl acetate (DOA).

Korean Unexamined Patent Publication Nos. 2008-0102938 and 2009-0062108 is directed to techniques for forming fine pores in a catalytic layer of an electrode by mixing a material containing an inorganic salt (e.g., MgSO₄ or LiCO₃) with a slurry to produce a catalytic layer and treating the catalytic layer with an acid to elute the inorganic salt.

However, these techniques do not provide satisfactory control over the size of the pores in the catalytic layer. That is, the plasticizer is not a material whose shape or size is specified and the material containing the inorganic salt is mainly present in the form of fine particles whose size is difficult to control. Further, the plasticizer and the inorganic salt are dissolved or ionized and are present in various forms in a high boiling alcohol, water or an organic solvent, which is a solvent commonly used in the preparation of a catalyst slurry. This dissolution or ionization makes it very difficult to control the size and dispersion state of the pores in the catalytic layer.

### SUMMARY OF THE INVENTION

The present invention provides a catalyst slurry composition for an electrode of a fuel cell that uses spherical silica as a porogen to easily control the size of pores in the electrode, to achieve large surface area and pore volume of the electrode and to contribute to an improvement in the performance and lifespan of the fuel cell. The present invention further provides a catalytic layer for a fuel cell electrode using the catalyst slurry composition, a method for producing the catalytic layer, and a membrane-electrode assembly including the catalytic layer.

In exemplary embodiments, the catalyst slurry composition of the invention includes 100 parts by weight of an active metal, about 5 to about 30 parts by weight of a binder polymer, and about 6 to about 70 parts by weight of spherical silica.

In exemplary embodiments, the spherical silica may be colloidal silica dispersed in a solvent, dried spherical silica or a combination thereof.

The spherical silica may have a particle diameter of about 1 nm to about 5 μm. In exemplary embodiments, the spherical silica may have a particle diameter of about 15 nm to about 1,000 nm.

The composition may further include a solvent. The solvent may be present in an amount of about 100 to about 300 parts by weight, based on 100 parts by weight of the active metal.

The present invention further provides a catalytic layer for a fuel cell electrode. In exemplary embodiments, the catalytic layer includes an active metal and a binder polymer, contains pores having a diameter of about 1 nm to about 5 μm formed by the removal of spherical silica, and has a pore volume of about 20 to about 150 cm³/g and a specific surface area of about 5 to about 15 m²/g.

The catalytic layer may have a thickness of about 10 to about 50 μm.

In exemplary embodiments, the catalytic layer may be supported by an electrode substrate. The electrode substrate may be carbon paper or cloth.

The present invention also provides a membrane-electrode assembly using the catalytic layer. In exemplary embodiments, the membrane-electrode assembly include a polymer electrolyte membrane, and an anode and a cathode positioned at both sides of the polymer electrolyte membrane so as to be opposite to each other wherein at least one of the anode and the cathode is the catalytic layer.

In exemplary embodiments, the membrane-electrode assembly has a maximum power density of about 90 to about 150 mW/cm² and a current density (at 0.45 V) of about 90 to about 180 mA/cm² at an operational temperature of 60° C. when 1 M methanol fuel and air are fed in a stoichiometric ratio of 2.5 into the electrodes having an area of 13.9 cm².

The present invention further provides a method for producing a catalytic layer for a fuel cell electrode. In exemplary embodiments, the method includes preparing a catalyst slurry composition in which spherical silica is dispersed, coating the catalyst slurry composition on a support to form a catalytic layer, and treating the catalytic layer with an alkaline solution to remove the spherical silica from the catalytic layer, leaving pores in the catalytic layer.

### BRIEF DESCRIPTION OF THE DRAWINGS

The above and other aspects, features and advantages of the invention will become apparent from the following detailed description in conjunction with the accompanying drawings, in which:

FIG. 1 is a cross-sectional view schematically illustrating a membrane-electrode assembly according to an exemplary embodiment of the present invention;

FIG. 2 is a cross-sectional view schematically illustrating a membrane-electrode assembly according to another exemplary embodiment of the present invention;

FIG. 3 is a scanning electron microscope (SEM) image of spherical silica particles produced in Example 1;

FIG. 4 is a cross-sectional SEM image of a catalyst-coated membrane (CCM) constructed in Example 1;

FIG. 5 is a SEM image of a cathode before treatment with an alkaline solution in Example 1;

FIG. 6 is a SEM image of a cathode after treatment with an alkaline solution in Example 1;

FIG. 7 is a SEM image of a catalytic layer as a cathode produced in Comparative Example 1;

FIG. 8 is a photograph showing a state in which a catalytic layer produced in Comparative Example 3 was unsuccessfully transferred to a Nafion membrane;

FIG. 9 is a graph illustrating current-voltage (I-V) curves of membrane-electrode assemblies manufactured in Examples 1 and 2 and Comparative Example 1;

FIG. 10 is a graph illustrating current-voltage (I-V) curves of membrane-electrode assemblies manufactured in Examples 3-5 and Comparative Example 2; and

FIG. 11 is a graph comparing the volume and surface area of pores in a catalytic layer produced in Example 1 with those of pores in a catalytic layer produced in Comparative Example 1.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Embodiments of the invention will now be described in detail with reference to the accompanying drawings.

Catalyst Slurry Composition for Fuel Cell Electrode

Aspects of the present invention provide a catalyst slurry composition for a fuel cell electrode including an active metal, a binder polymer and spherical silica.

(a) Active Metal

The active metal may be of any type so long as it participates in the reactions of a fuel cell and exhibits catalytic activity. In exemplary embodiments, the active metal may be a platinum-type catalyst, for example platinum or a platinum alloy, or non-platinum catalyst. Examples of such active metals include without limitation Pt, Ru, Rh, Mo, Os, Ir, Re, Pd, V, Co, W, PtRu, PtW, PtMo, PtCr, PtPd, PtSn, PtCo, PtNi, PtFe, PtRuRh, PtRuW, PtRuMo, PtRuV, PtFeCo, PtRuRhNi, PtRuSnW, PtRuCoW, PtRuMoW, PdRu, PdSn, FeNiCo, WC, and the like. These active metals may be used alone or as a mixture of two or more thereof.

The active metal may be used without modification. Alternatively, the active metal may be supported on a carrier to increase its degree of dispersion and availability. Examples of the carrier may include without limitation carbon-based materials, such as graphite, carbon black, carbon nanotubes, carbon nanofibers, carbon nanowires, carbon nanoballs and activated charcoal, non-carbon based materials, such as alumina, silica, zirconia, and titania, and the like, and combinations thereof.

(b) Binder Polymer

The binder polymer may be a cationic conductive polymer or a non-ionic conductive polymer.

The term “cationic conductive polymer” refers to a polymer that has cation-exchange groups and functions as a conductor through which hydrogen ions created at an anode of a fuel cell are allowed to migrate in catalytic layers of the anode and a cathode. At the same time, the cationic conductive polymer functions as a binder that prevents the catalyst from escaping from the catalytic layers. Each of the cation-exchange groups may be present in the form of an acid or a salt. Exemplary cation-exchange groups include without limitation sulfonic acid, phosphonic acid, carboxylic acid and sulfonamide groups.

Examples of the polymers having the cation-exchange groups include without limitation polysulfones, polyether ketones, polyethers, polyesters, polybenzimidazoles, polyimides, polyphenylene sulfides, polyphenylene oxides, fluorinated polymers such as Nafion, which is a registered trademark of DuPont, and the like, and combinations thereof.

The term “non-ionic conductive polymer” refers to a polymer that contains no cation-exchange group and functions as a binder that fixes the catalyst to the catalytic layer. Another role of the non-ionic conductive polymer is a conductor through which hydrogen ions are allowed to migrate in the catalytic layer when the catalytic layer absorbs a liquid electrolyte such as phosphoric acid. Examples of such non-ionic conductive polymers include, but are not necessarily limited to, fluorinated polymers, such as polyvinylidene fluoride (PVdF) and poly(vinylidene fluoride-co-hexafluoropropylene) (P(VdF-HFP), polybenzimidazole (PBI), polyimide (PI), polyphenylene sulfide (PPS), polyphenylene oxide (PPO), polyethylene oxide (PEO), polypropylene oxide (PPO), polyvinyl chloride (PVC), polyacrylonitrile (PAN), and the like, and combinations thereof.

These binder polymers may be used alone or as a mixture of two or more thereof.

In exemplary embodiments, the binder polymer may be used in an amount of about 5 to about 30 parts by weight, for example about 10 to about 25 parts by weight, based on 100 parts by weight of the active metal. In some embodiments, the binder polymer may be used in an amount of about 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the binder polymer can be in a range from about any of the foregoing amounts to about any other of the foregoing amounts.

Within this range, the dispersed catalyst particles may be stably fixed to the catalytic layer to prevent the catalyst from escaping from the catalytic layer. In addition, the possibility of formation of triphasic interfaces between the catalyst, the binder polymer and fuel can be increased, which improves the performance of a membrane-electrode assembly.

(c) Spherical Silica

Various kinds of synthetic silica products are known, for example, fumed silica produced by dry processes and colloidal silica and silica gel produced by wet processes. Colloidal silica or silica gel produced by wet processes can be used as the spherical silica because its size is easy to control.

The spherical silica can be used as a porogen in the catalytic layer. The spherical silica may have a particle diameter ranging from about 1 nm to about 5 μm, for example about 15 nm to about 1,000 nm, as another example about 50 to about 800 nm and as another example about 100 to about 500 nm. This size range ensures easy discharge of water created in the cathode from the catalytic layer and smooth migration of fuel to the catalyst of the catalytic layer. In addition, the catalytic layer can be made uniform and the adhesion of the catalytic layer to a support is sufficient to prevent the catalyst from escaping, which shortens the lifespan of the fuel cell

A sol of colloidal silica dispersed in a solvent may be used. The colloidal silica sol may be dried to remove the solvent before use.

In exemplary embodiments, the silica having a particle diameter in the range of about 1 nm to about 100 nm is used in the form of a sol to maintain its dispersion state in a solvent. In an alternative embodiment, a sol or a dry state of the silica having an average particle diameter exceeding 100 nm is directly used in the preparation of the slurry composition. In the case where a solvent is used to disperse the colloidal silica in a sol, it is necessary to vary the dispersion solvent depending on the kind of a solvent or the binder polymer of the catalyst slurry composition. Examples of the dispersion solvent include without limitation water, methanol (MeOH), ethanol (EtOH), ethylene glycol (EG), isopropyl alcohol (IPA), methyl ethyl ketone (MEK) and the like, and mixtures thereof.

The spherical silica is advantageously used for the preparation of the catalyst slurry composition because of its controllable diameter. Based on this advantage, the size of pores present in the catalytic layer can be controlled so as to be suitable for the operational conditions of a fuel cell. In contrast, since the size and shape of fumed silica, silica aerogel and silica xerogel are difficult to control, they are not suitable for forming size-controlled pores in the catalytic layer.

The spherical silica may be used in an amount of about 6 to about 70 parts by weight, for example about 10 to about 50 parts by weight, as another example about 15 to about 45 parts by weight, and as yet another example about 55 to about 65 parts by weight, based on 100 parts by weight of the active metal. In some embodiments, the spherical silica may be used in an amount of about 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 parts by weight. Further, according to some embodiments of the present invention, the amount of the spherical silica can be in a range from about any of the foregoing amounts to about any other of the foregoing amounts.

Within this range, a sufficiently large number of pores can be formed to enable easy discharge of water created in the cathode and smooth feed of fuel into the catalyst and to ensure good adhesion of the catalytic layer to a support.

(d) Solvent

The catalyst slurry composition may further include a solvent. Any polar solvent may be used as the solvent. Examples of such solvents include, but are not necessarily limited to, water, methanol, ethanol, isopropyl alcohol, 1-propanol, ethylene glycol, polyhydric alcohols, N-methyl-2-pyrrolidnone (NMP), dimethylacetamide (DMAc), dimethylsulfoxide (DMSO), tetrahydrofuran (THF), dimethylformamide (DMF), and the like, and combinations thereof.

The solvent may be present in an amount of about 100 to about 300 parts by weight, for example about 150 to about 250 parts by weight, based on 100 parts by weight of the active metal.

Catalytic Layer for Fuel Cell Electrode and its Production

The present invention also provides a method for producing a catalytic layer for a fuel cell electrode by using the catalyst slurry composition. In one embodiment, the method includes preparing a catalyst slurry composition in which spherical silica is dispersed, coating the catalyst slurry composition on a support to form a catalytic layer, and treating the catalytic layer with an alkaline solution to remove the spherical silica from the catalytic layer, leaving pores in the catalytic layer.

The spherical silica may be dried silica or colloidal silica dispersed in a solvent. The spherical silica may be monodisperse spherical silica having a particle diameter in a particular range or a mixture of two or more kinds of monodisperse silica particles having different diameters. Alternatively, the spherical silica may be a mixture of polydisperse spherical silica particles having different sizes. In exemplary embodiments, the spherical silica having an average particle diameter of about 1 nm to about 100 nm may be dispersed in a solvent to form a colloid before use. In an alternative embodiment, the spherical silica having an average particle diameter exceeding 100 nm may be dried before use.

Examples of the support include without limitation release papers, polymer membranes for fuel cells, carbon paper and carbon cloth.

The catalyst slurry composition can be coated by any suitable technique known in the art. Examples of such coating techniques include, but are not particularly limited to, bar coating, screen printing and spraying.

The catalyst slurry composition coated on the support is dried to form a catalytic layer. The catalytic layer can be treated with an alkaline solution to dissolve and remove the spherical silica. The alkaline solution used to elute the spherical silica may be a solution of an alkali metal hydroxide (such as NaOH or KOH) or an alkaline-earth metal hydroxide in distilled water. The alkaline solution may have a concentration of about 1 to about 15 M, which is sufficient to dissolve the spherical silica. The concentration of the alkaline solution can be increased in order to shorten the time required to completely remove the silica. Taking into consideration various factors, for example, the removal efficiency of the silica, the preparation cost of the alkaline solution and the hazards of the high-concentration alkaline solution, the concentration of the alkaline solution may be adjusted from about 3 M to about 10 M. For more effective elution of the silica from the catalytic layer, a high temperature of about 50 to about 95° C. can be maintained.

The method may further include treating the porous catalytic layer with an acid. This acid treatment may be conducted in an acidic aqueous solution, such as a sulfuric acid, nitric acid or hydrochloric acid solution, at a temperature of about 30 to about 110° C., for example about 50 to about 100° C. By the acid treatment, cations can be exchanged in the binder of the catalytic layer and a polymer membrane. In addition, cations (e.g., K⁺ ions) can be replaced with hydrogen ions by the acid treatment.

The removal of the spherical silica makes the catalytic layer porous. The spherical silica acts as a porogen to easily control the size and volume of pores.

In exemplary embodiments, the catalytic layer may have pores whose diameter is from about 1 nm to about 5 μm, for example about 15 nm to about 1,000 nm. In exemplary embodiments, the pores may have a diameter of about 50 to about 800 nm, for example, about 100 to about 500 nm.

The catalytic layer may have a pore volume of about 20 to about 150 cm³/g. In exemplary embodiments, the pore volume may be from about 25 to about 100 cm³/g, for example, about 30 to about 80 cm³/g.

The catalytic layer may have a specific surface area of about 5 to about 15 m²/g, In exemplary embodiments, the specific surface area may be from about 5 to about 10 m²/g.

A membrane-electrode assembly including the catalytic layer may have a maximum power density of about 90 to about 150 mW/cm² and a current density (at 0.45 V) of about 90 to about 180 mA/cm² (at 0.45 V) at an operational temperature of 60° C. when 1 M methanol fuel and air are fed in a stoichiometric ratio of 2.5 into electrodes having an area of 13.9 cm².

In one embodiment, the catalytic layer may have a thickness of about 10 to about 50 μm.

The catalytic layer may be supported by an electrode substrate. The electrode substrate plays a role in diffusing fuel and an oxidant into the catalytic layer while supporting the electrode so that the fuel and the oxidant approach the catalytic layer. The electrode substrate may be a conductive one, for example, carbon paper or cloth. Other examples of such electrode substrates include, but are not necessarily limited to, carbon felts, metal cloth and metal-plated polymer cloth. In another embodiment, the electrode substrate may be treated with a fluorinated resin for water repellency.

Membrane-Electrode Assembly Using the Catalytic Layer for Fuel Cell Electrode and its Manufacture

The present invention further provides a membrane-electrode assembly using the catalytic layer.

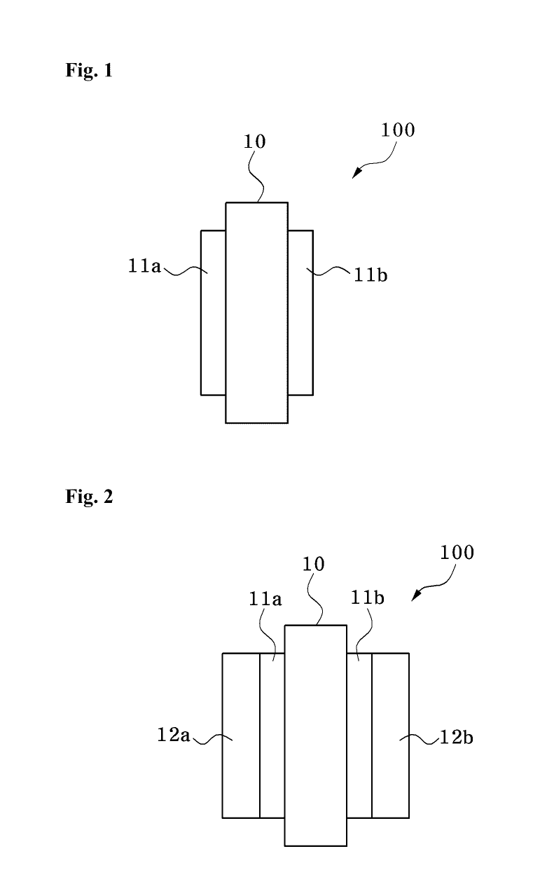

FIG. 1 is a cross-sectional view schematically illustrating a membrane-electrode assembly 100 according to an exemplary embodiment of the present invention. Referring to FIG. 1, the membrane-electrode assembly 100 includes a polymer electrolyte membrane 10, and an anode 11a and a cathode 11b positioned on opposing sides of the polymer electrolyte membrane so as to be opposite to each other wherein at least one of the anode and the cathode serves as the catalytic layer. In exemplary embodiments, the porous catalytic layer may be applied to either the cathode or the anode or both.

FIG. 2 is a cross-sectional view schematically illustrating a membrane-electrode assembly 100 according to another exemplary embodiment of the present invention. Referring to FIG. 2, the membrane-electrode assembly 100 may further include electrode substrates 12a and 12b disposed on the outer sides of the anode 11a and the cathode 11b, respectively. The electrode substrates play a role in diffusing fuel and an oxidant into the catalytic layer so that the fuel and the oxidant approach the catalytic layer.

The membrane-electrode assembly may be manufactured by suitable methods known in the art.

In one embodiment, the membrane-electrode assembly may be manufactured by a method including: preparing a catalyst slurry composition in which spherical silica is dispersed; coating the catalyst slurry composition on a release paper and drying the catalyst slurry composition to form a catalytic layer; transferring the catalytic layer to a polymer membrane for a fuel cell by hot pressing and removing the release paper to construct a catalyst-coated membrane (CCM) in which the catalytic layer is integrated with the polymer membrane; treating the CCM with an alkaline solution to remove the spherical silica from the CCM, leaving pores in the catalytic layer; and bonding the CCM to carbon paper. The method may further include treating the CCM with an acid to exchange cations in the polymer membrane or a binder of the catalytic layer before the CCM is bonded to the carbon paper.

In a further embodiment, the membrane-electrode assembly may be manufactured by a method including: preparing a catalyst slurry composition in which spherical silica is dispersed; coating the catalyst slurry composition on a polymer membrane for a fuel cell and drying the catalyst slurry composition to construct a catalyst-coated membrane (CCM) in which the catalytic layer is directly coated on the polymer membrane; treating the CCM with an alkaline solution to remove the spherical silica from the CCM, leaving pores in the catalytic layer; and bonding the CCM to carbon paper. The method may further include treating the CCM with an acid to exchange cations in the polymer membrane or a binder of the catalytic layer before the CCM is bonded to the carbon paper.

In another embodiment, the membrane-electrode assembly may be manufactured by a method including: preparing a catalyst slurry composition in which spherical silica is dispersed; coating the catalyst slurry composition on carbon paper for a fuel cell electrode and drying the catalyst slurry composition to construct a catalyst-coated electrode (CCE) in which a catalytic layer is directly coated on the carbon paper; treating the CCE with an alkaline solution to remove the spherical silica from the CCE, leaving pores in the catalytic layer; and bonding the CCE to a polymer membrane for a fuel cell. The method may further include treating the CCE with an acid before the CCE is bonded to the polymer membrane.

Hereinafter, the constitution and functions of the present invention will be explained in more detail with reference to the preferred embodiments of the present invention. The following examples are provided for illustrative purposes only and are not to be construed as limiting the invention.

### EXAMPLES

### Example 1

### (1) Production of Spherical Silica

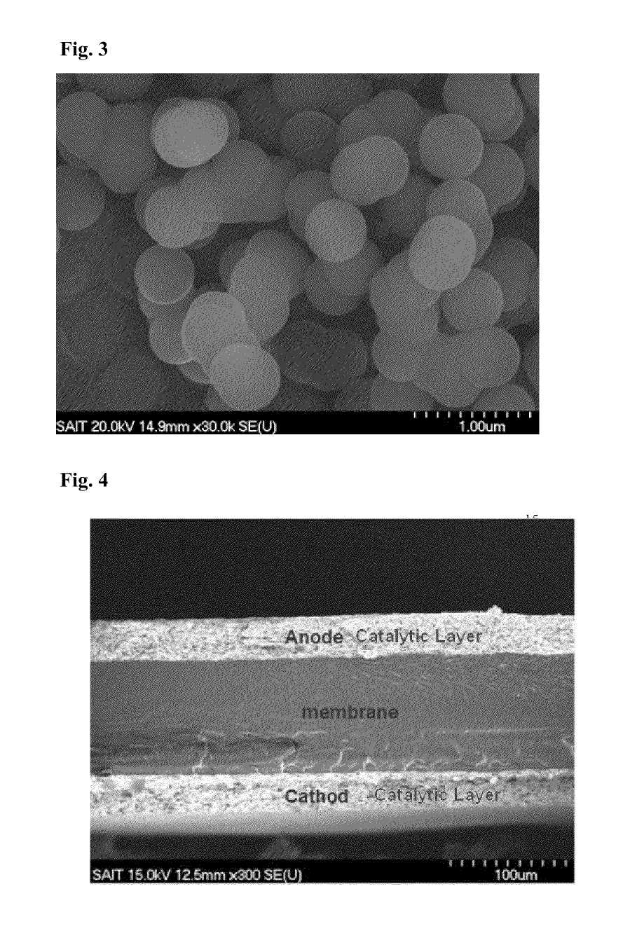

0.3 M TEOS is added to a solution of 3.3 M 1-propanol, 6.3 M methanol, 15.6 M water and 2.0 M NH₃. An aqueous solution of NH₄OH (average 20 wt %) is used as the NH₃ solution. After stirring at room temperature for 20 min, spherical colloidal silica is observed in the solution. The spherical silica particles are separated using a centrifuge and dried in a vacuum oven. The spherical silica particles are found to have an average diameter of 400 nm. A SEM image of the spherical silica is shown in FIG. 3.

### (2) Preparation of Catalyst Slurry Composition

15 parts by weight of Nafion (DuPont) as a binder is mixed with 213 parts by weight of a mixed solvent of 1-propanol, ethylene glycol (EG) and distilled water to prepare a binder solution. 100 parts by weight of PtRu as a catalyst is dispersed in the binder solution to obtain a slurry. 20 parts by weight of the spherical silica produced above is dispersed in the slurry to prepare a catalyst slurry composition for an anode having a solids content of 38% by weight.

The above procedure is repeated except that platinum is used as a catalyst to prepare a catalyst slurry composition for a cathode.

### (3) Production of Catalytic Layer and Manufacture of Membrane-Electrode Assembly

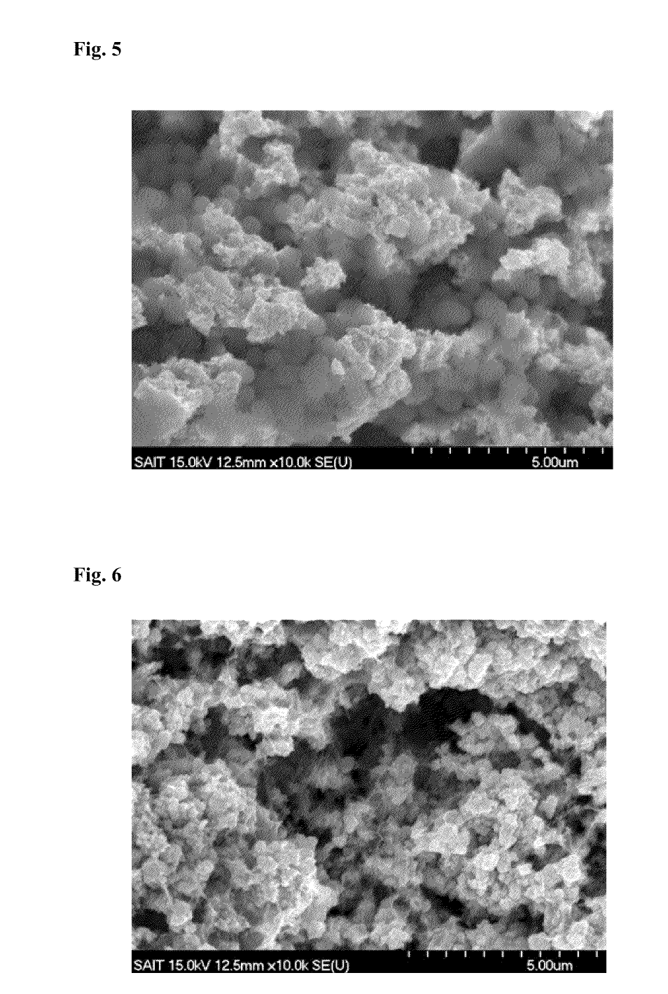

Each of the catalyst slurry compositions for an anode and the catalyst slurry composition for a cathode is coated on a polyimide film using a bar coater. The coating is dried to form a catalytic layer in which the amount of the catalyst per unit area reached about 5 mg/cm². The catalytic layer is transferred to a Nafion membrane as a cationic conductive polymer via a hot pressing process at 135° C. to construct a catalyst-coated membrane (CCM). A cross-sectional SEM image of the CCM is shown in FIG. 4. The CCM is impregnated with an 8 M alkaline aqueous solution of KOH while maintaining the temperature of the alkaline aqueous solution at 80° C. to remove the spherical silica from the catalytic layer. After passage of a predetermined time, the alkaline aqueous solution is replaced three times with new ones to sufficiently remove the silica particles. The alkali-treated CCM is treated with a 1 M aqueous solution of sulfuric acid at 95° C. By the acid treatment, K⁺ ions present in the binder of the catalytic layer and the polymer membrane are exchanged with hydrogen ions. The resulting CCM having the porous catalytic layer is hot-pressed with carbon paper having a gas diffusion layer (GDL) at 125° C. to manufacture a membrane-electrode assembly. FIGS. 5 and 6 are SEM images of the cathode before and after treatment with the alkaline solution, respectively. FIGS. 5 and 6 show that a large number of pores are formed in the catalytic layer after alkali treatment.

### Example 2

A catalytic layer is produced and a membrane-electrode assembly is manufactured in the same manner as in Example 1, except that a spherical silica sol having a solid content 30 wt % (SS-SOL 30F, S-Chemtech) is used instead of the spherical silica particles having a diameter of 400 nm and the content of distilled water is controlled to prepare a slurry composition having a solids content of 36 wt % in which the catalyst is dispersed.

### Example 3

The procedure of Example 1 is repeated except that the spherical silica is used in an amount of 10 parts by weight and only a catalyst slurry composition for a cathode is prepared.

### Example 4

The procedure of Example 3 is repeated except that the spherical silica is used in an amount of 20 parts by weight and only a catalyst slurry composition for a cathode is prepared.

### Example 5

The procedure of Example 3 is repeated except that the spherical silica is used in an amount of 30 parts by weight and only a catalyst slurry composition for a cathode is prepared.

### Comparative Example 1

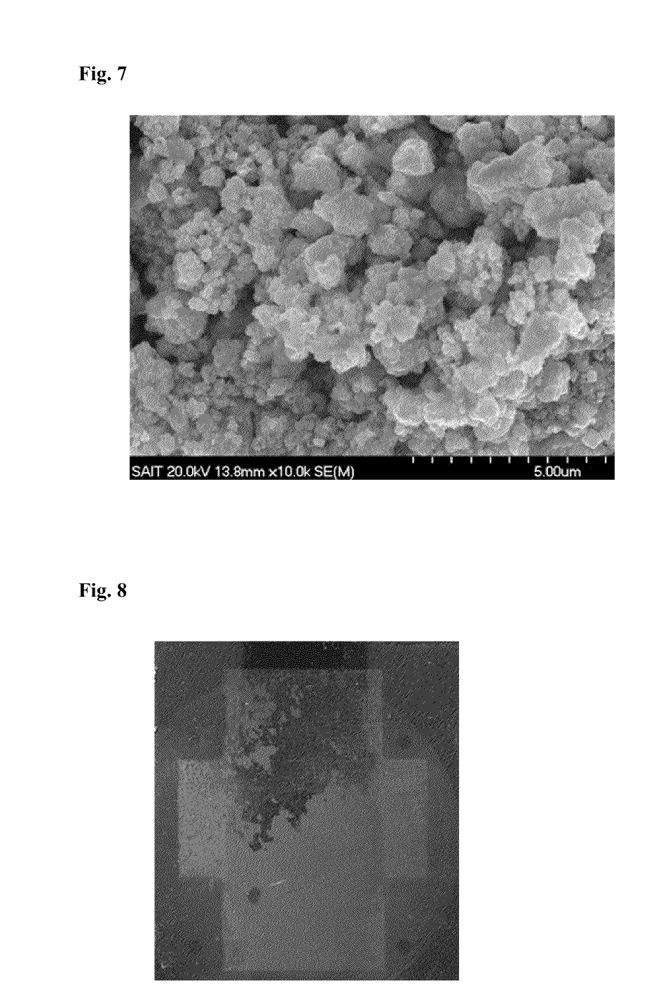

The procedure of Example 1 is repeated except that no spherical silica is used and no alkali treatment is conducted. FIG. 7 is a SEM image of the catalytic layer as a cathode. As shown in FIG. 7, when no porogen is used, the catalyst is agglomerated with the binder polymer. Interstices present between the agglomerates are observed, together with only a small number of pores.

### Comparative Example 2

The procedure of Example 3 is repeated except that the spherical silica is used in an amount of 5 parts by weight and only a catalyst slurry composition for a cathode is prepared.

### Comparative Example 3

The procedure of Example 3 is repeated except that the spherical silica is used in an amount of 100 parts by weight and only a catalyst slurry composition for a cathode is prepared. Unsuccessful transfer of the catalytic layer to the polymer membrane is observed and it is thus impossible to manufacture a membrane-electrode assembly, as shown in FIG. 8.

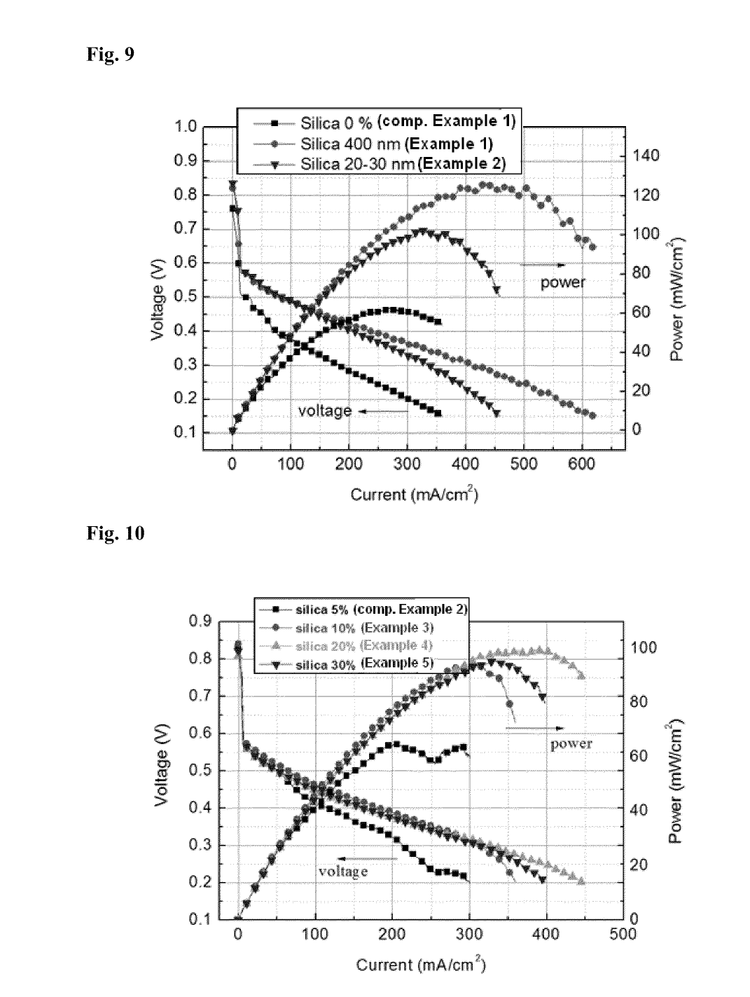

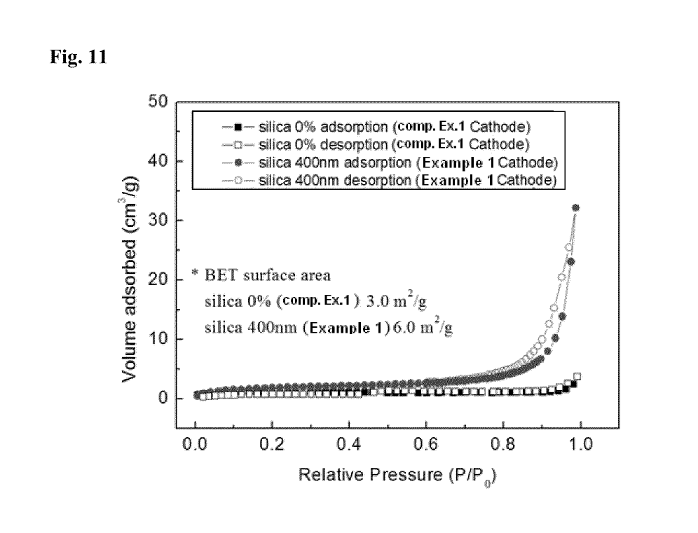

Bipolar plates are coupled to both surfaces of each of the membrane-electrode assemblies manufactured in Examples 1-5 and Comparative Examples 1-3 to fabricate a DMFC unit cell. The performance characteristics of the unit cell are evaluated. Air and 1 M methanol fuel are fed in a stoichiometric ratio (2.5) into the cathode and the anode, each of which has an area of 13.9 cm² while maintaining the temperature at 60° C. In the Tafel evaluation (I-V evaluation), changes in voltage are measured while increasing the current at a rate of 5 mA/sec, starting from the open circuit voltage (OCV) to 0.15 or 0.2 V. As a result, a current/voltage curve for the unit cell is obtained. FIG. 9 shows the performance characteristics of the unit cells including the membrane-electrode assemblies manufactured in Examples 1-2 and Comparative Example 1, and FIG. 10 shows current-voltage (I-V) curves for the unit cells including the membrane-electrode assemblies manufactured in Examples 3-5 and Comparative Example 2. The maximum power density values (mW/cm²) and the current density values (mA/cm²) (at 0.45 V) of the unit cells are shown in Table 1.

TABLE 1

| | | Spherical silica | | | |
|---|---|---|---|---|---|
| | | Size | Content | Maximum power | Current density, |
| | Electrode | (nm) | (Part by weight) | density, mW/cm² | mA/cm² |
| Example 1 | Anode | 400 | 20 | 125 | 156 |
| | Cathode | 400 | 20 | 125 | 156 |
| Example 2 | Anode | 20~30 | 20 | 108 | 144 |
| | Cathode | 20~30 | 20 | 108 | 144 |
| Example 3 | Cathode | 400 | 10 | 93 | 115 |
| Example 4 | Cathode | 400 | 20 | 98 | 94 |
| Example 5 | Cathode | 400 | 30 | 95 | 99 |
| Comparative | Cathode | — | — | 61 | 52 |
| Example 1 | | | | | |
| Comparative | Cathode | 400 | 5 | 65 | 74 |
| Example 2 | | | | | |

| | | | | |
|---|---|---|---|---|
| Comparative | Cathode | 400 | 100 | Impossible to manufacture membrane- |
| Example 3 | | | | electrode assembly because of |
| | | | | unsuccessful transfer of catalytic layer |

As shown in Table 1 and FIG. 9, the unit cell of Comparative Example 1, in which no pores are formed because spherical silica is not used, shows much inferior performance characteristics to the unit cells of Examples 1 and 2, each of which has the porous catalyst formed using spherical silica.

The performance characteristics of the unit cell fabricated in Example 1 are compared to those of the unit cell fabricated in Example 2 to examine the influence of the size of the spherical silica on the performance of the membrane-electrode assemblies. From the voltage curves of FIG. 9, it can be seen that the membrane-electrode assembly of Example 2, which is manufactured using the spherical silica whose particle diameter is as small as 20 to 30 nm, exhibited a more rapid decrease in voltage with increasing current generated in the unit cell than the membrane-electrode assembly of Example 1. The reason for this phenomenon is that a large amount of water created in the cathode at high currents is not sufficiently discharged through the catalytic layer containing the smaller pores. Another reason is that fuel failed to smoothly migrate to the catalyst of the catalytic layer through the smaller pores formed using the silica with a smaller diameter. At high current values, a much larger amount of fuel must be smoothly fed into the catalyst of the catalytic layer. That is, the migration of fuel in the catalytic layer acted as a rate-limiting factor in power generation. Therefore, the choice of a suitable size of spherical silica is required in the manufacture of a membrane-electrode assembly having a porous catalytic layer so as not to hinder the discharge of water from a cathode and the migration of fuel to the catalytic layer within voltage and current ranges for the operation of a fuel cell.

As shown in FIG. 10, the unit cell of Comparative Example 2, in which silica is present in a smaller amount, showed poor performance characteristics compared to the unit cells of Examples 3-5. Since the number of pores formed in the catalytic layer is proportional to the amount of the silica used, the rate-limiting phenomenon resulting from the migration of the fuel becomes more serious with increasing current. That is, as the spherical silica content increases, the performance characteristics of the unit cell are improved. The maximum current density of the unit cell of Comparative Example 2 is 65 mW/cm², whereas the maximum current density values of the unit cells of Examples 3-5 are above 93 mW/cm².

The catalytic layers of the cathodes in Example 1 and Comparative Example 1 are analyzed for BET in order to compare their pore volumes and surface areas. First, the catalytic layer formed in Example 1 is transferred to one surface of a Nafion membrane. Then, alkaline and acid treatments are sequentially conducted in the same manner as described in Example 1 to remove the silica, leaving pores in the catalytic layer. Thereafter, the BET of the catalytic layer is measured to determine the volume adsorbed (i.e. pore volume) and surface area of the porous catalytic layer. For comparison, the catalytic layer of Comparative Example 1 is transferred to one surface of a Nafion membrane. No alkali treatment is conducted because no spherical silica is used. The two specimens are analyzed for BET using an analyzer (Micromeritics). The volume adsorbed (i.e. pore volume) per unit weight and the surface area per unit weight are calculated by subtracting the weight of the polymer membrane from the total weight of the membrane-electrode assembly. The results are shown in Table 2 and FIG. 11.

TABLE 2

| | Volume adsorbed | |
|---|---|---|
| Example No. | (Pore volume), cm³/g | Surface area, m²/g |
| Example 1 | 32.0 | 6.0 |
| Comparative Example 1 | 4.0 | 3.0 |

As can be known from the results in Table 2 and FIG. 11, the volume adsorbed (i.e. pore volume) and surface area of the catalytic layer formed in Example 1 are much larger than those of the catalytic layer formed in Comparative Example 1.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A catalyst slurry composition for an electrode of a fuel cell, comprising 100 parts by weight of an active metal, about 5 to about 30 parts by weight of a binder polymer, and about 6 to about 70 parts by weight of spherical silica.

2. The catalyst slurry composition according to claim 1, wherein said spherical silica is colloidal silica dispersed in a solvent, dried spherical silica or a combination thereof.

3. The catalyst slurry composition according to claim 1, wherein said spherical silica has a particle diameter of about 1 nm to about 5 μm.

4. The catalyst slurry composition according to claim 1, wherein said spherical silica has a particle diameter of about 15 nm to about 1,000 nm.

5. The catalyst slurry composition according to claim 1, further comprising about 100 to about 300 parts by weight of a solvent, based on 100 parts by weight of the active metal.

6. A catalytic layer for a fuel cell electrode formed using the catalyst slurry composition according to claim 1.

7. The catalytic layer according to claim 6, wherein said catalytic layer contains pores having a diameter of about 1 nm to about 5 μm, and has a pore volume of about 20 to about 150 cm³/g and a specific surface area of about 5 to about 15 m²/g.

8. The catalytic layer according to claim 6, wherein said catalytic layer has a thickness of about 10 to about 50 μm.

9. The catalytic layer according to claim 6, wherein said catalytic layer is supported by an electrode substrate.

10. The catalytic layer according to claim 9, wherein said electrode substrate is carbon paper or cloth.

11. A membrane-electrode assembly comprising a polymer electrolyte membrane, and an anode and a cathode positioned at both sides of the polymer electrolyte membrane so as to be opposite to each other wherein at least one of the anode and the cathode comprises the catalytic layer according to claim 6.

12. The membrane-electrode assembly according to claim 11, wherein said membrane-electrode assembly has a maximum power density of about 90 to about 150 mW/cm² and a current density (at 0.45 V) of about 90 to about 180 mA/cm² at an operational temperature of 60° C. when 1 M methanol fuel and air are fed in a stoichiometric ratio of 2.5 into the electrodes having an area of 13.9 cm².

13. A method for producing a catalytic layer for a fuel cell electrode, comprising
coating the catalyst slurry composition according to claim 1 on a support to form a catalytic layer, and
treating the catalytic layer with an alkaline solution to remove the spherical silica from the catalytic layer, leaving pores in the catalytic layer.
